(19) United States
(12) Patent Application Publication
(10) Pub. No.: US 2008/0188191 A1
(43) Pub. Date: Aug. 7, 2008

(54) Network monitoring system

(75) Inventors: Peter G. Farrimond, Harpenden (GB); Dan Hubscher, South Orange, NJ (US); Adinarayana Kadiyam, London (GB); Ian Newman, Ilford (GB); David McCallum, Hertfordshire (GB); Alistair Munro, Kent (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS public limited company

(21) Appl. No.: 11/702,665

(22) Filed: Feb. 6, 2007

(51) Int. Cl. H04B 17/00

(52) U.S. Cl. 455/115.2

(57) ABSTRACT

A telecommunications network comprises a plurality of network terminations interconnected through the network, each network termination being connectable to network termination equipment configurable for the input or output of data communicated between the terminations over the network.

The data collection and generation equipment is controlled by a central server to generate data required for the monitoring of this performance, such as latency in a connection between two of the terminations. This server has configuration means for controlling a data retrieval means and data processing means to generate the outputs required of it, and is associated with a data storage means comprising means to store data relating to the arrangement of the network and the network terminations. The configuration means identifies, from the network data store, the network terminations required to perform the data collection required and transmits instructions to them to generate this data.

Each network termination comprises monitoring means for monitoring the performance of traffic feeds between the network terminations, each monitoring means comprises data generation and collection equipment independent of the network termination equipment, and the data collection and generation equipment is arranged to exchange test signals with other such equipment and to monitor the performance of said signals, under the instructions of the central server.

The use of a configuration having monitoring equipment at every network termination, in conjunction with the application of measurements only across those paths where required, allows an improvement over prior art systems in the frequency and accuracy of measurements, and the rate at which measurement data can be collected and disseminated.

The present invention relates to the monitoring of traffic flow performance of a communications connection. For some applications, the flow performance of traffic over a connection can be very significant. Although simple data rate is important, for some applications, latency and jitter are also significant.

Latency is the delay in transmission of data, and can be the consequence of a number of factors. Amongst these are the delays caused by encoding, decoding and compression of the data, any buffering or other queuing during the transmission process itself and, for a two-way system, the time taken at the remote end to process a query, instruction, etc and generate a response.

Latency is significant in voice systems because conversations take place in real time. It is usually less important in data transmission, but in some applications, where processes are operating almost in real time, latency can be very significant. Examples include the remote operation of machinery, where the operator relies on feedback from the machine's behaviour to control it, and in the financial services industry, where prices of commodities change very rapidly and it is necessary to respond quickly to incoming data. Delays in data can result in decisions being made on information that is no longer current. Even if the information is current when a decision is taken, delays in transmitting instructions based on that decision can result in the information no longer being current when the instructions are received.

Jitter is the variation of latency over time. This is a significant problem in voice systems, where such variation can lead to a noticeable deterioration in perceived quality. Also, in near-real-time data operations, variation in delay may be harder to compensate for than a steady delay.

Existing network monitoring systems tend to have small numbers of centrally based monitoring equipment, each monitoring very large numbers of paths to endpoints. This is relatively easy to configure but constrains performance. Monitoring every link from centrally based monitoring equipment would require a large overhead in data capture.

It would therefore be useful to be able to monitor and report the delays, and the variability in the delays, associated with individual information feeds. In particular, in the financial services industry, it would be desirable to provide information on the performance of automated trading systems, such as timeliness of a market feed, speed of trades, etc. in order to facilitate trading decisions, and to determine which of several possible feeds is currently supplying the most up to date information.

The present invention provides a telecommunications network comprising a plurality of network terminations interconnected through the network, each network termination being connectable to network termination equipment configurable for the input or output of data communicated between the terminations over the network, two or more of the network terminations comprising monitoring means for monitoring the performance of traffic feeds between the network terminations, each monitoring means comprising data generation and collection equipment independent of the network termination equipment, the data collection and generation equipment being arranged to exchange test signals with other such equipment and to monitor the performance of said signals.

The invention also provides a method of monitoring the performance of a telecommunications network, the network comprising a plurality of interconnected network terminations each connected to network termination equipment configurable for the input or output of data,

the method comprising the provision of monitoring means comprising data generation and collection equipment independent of the network termination equipment, and arranged to exchange test signals and to monitor the performance of said signals

The equipment at any given site may be configured to transmit or receive such test signals, but in a preferred embodiment the equipment at each site can perform both functions. The equipment may be configured to determine latency in a single direction by using an independent measure of time that is available to detectors at both ends of the link, for example a clock based on a satellite location system such as the GPS (Global Positioning System), so that complementary equipment at the remote end may determine the latency in the connection—that is to say, the time elapsed between transmission and receipt. The equipment may also generate a signal requesting a reply from another termination, so that the latency in the round-trip transmission may be determined. Such latency may be arranged to include processing time at the remote end, by instructing the remote end to perform some operation or to impose a time delay determined from measurement of the behaviour of the network termination equipment. Thus the round trip time can be determined for a request, for data or for a transaction, to be completed.

In embodiments configured for the financial services industry, the measurement may take measurements of the latency in market data information—that is to say, the time taken for changes in prices to be made available. It may also provide indications of transaction times—how quickly a dealer responds to a request to buy or sell stock. Both these factors are crucial to that industry, where rapid changes in prices require equally rapid responses. This requires highly granular measurement (sub-millisecond network latency) and very frequent reporting of measurements (typically every second).

As well as latency, the equipment may measure related properties such as jitter, and other properties such as error rates.

In a preferred embodiment the equipment is in communication with a network monitoring server which is configured to instruct the monitoring equipment to generate the test signals, and to transmit to the monitoring server data derived from the received signals. Each transmission to the monitoring server may be in response to an individual download command, or transmission may be made in response to predetermined conditions, set in an initial command, being met. Such conditions may be the exceeding of some threshold condition, or merely the passing of a predetermined period of time since the previous transmission.

The use of a configuration having monitoring equipment at every network termination, in conjunction with the application of measurements only across those paths where required allows an improvement over prior art systems in the frequency and accuracy of measurements, and the rate at which measurement data can be collected and disseminated.

An embodiment of the invention will now be described, by way of example, with reference to the drawings, in which

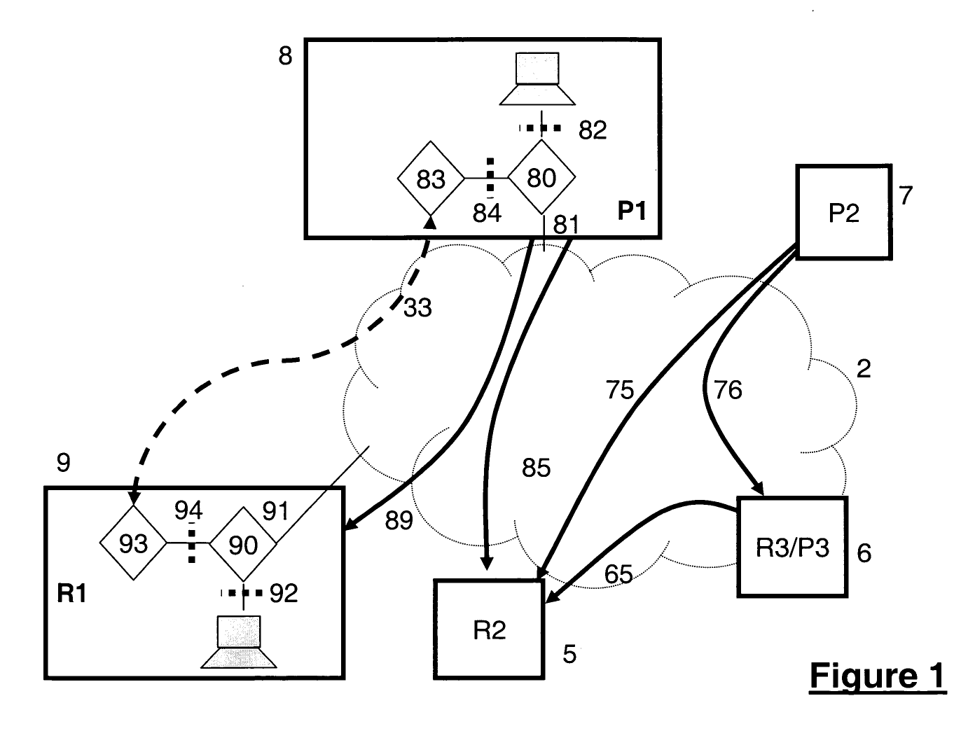

FIG. 1 is a schematic representation of a simple data network to which the invention has been applied

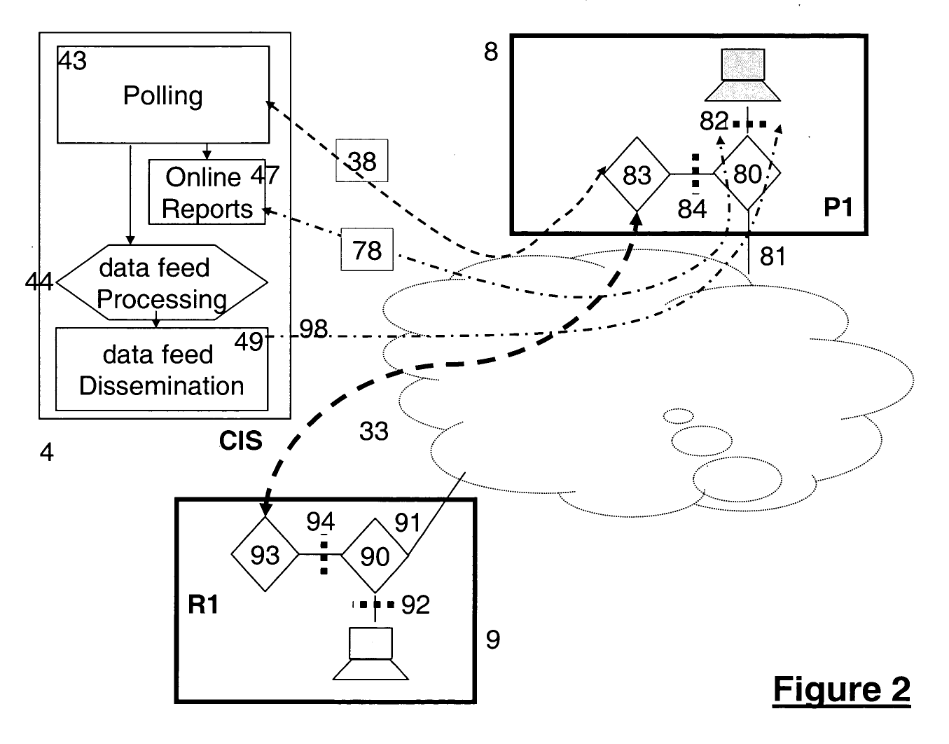

FIG. 2 is a schematic representation of a performance monitoring system for the data network of FIG. 1, operating according to the invention

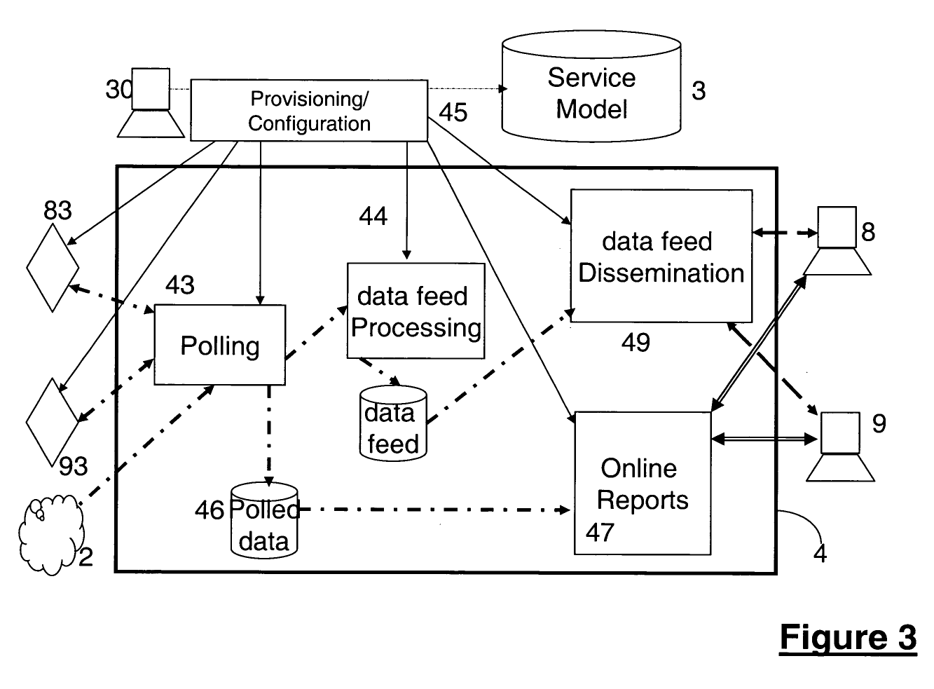

FIG. 3 is a schematic representation of the functions performed by the central instrumentation server of the performance monitoring system depicted in FIG. 2

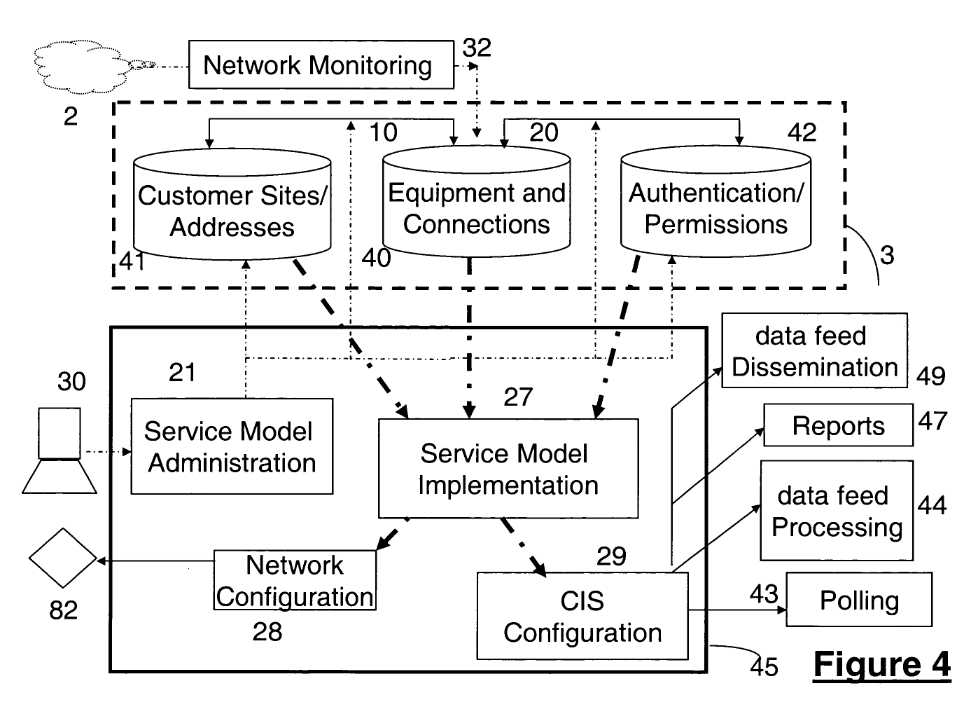

FIG. 4 is a schematic representation of the functions performed by the provisioning server of the central information server depicted in FIG. 3

Referring firstly to FIG. 1, the users of the network are collectively referred to herein as customers of the network operator. There are two categories of customer, namely information providers P (6, 7, 8), and information receivers (R) 5, 6, 9. It will be noted that a customer may belong to both categories, as in the example of customer P3/R3 (6).

Each information receiver (5, 6, 9) subscribes to data feeds provided by one or more of the information providers 6, 7, 8. In this example, receiver 9 subscribes to the service from provider 8 (feed 89), receiver 6 subscribes to the service from provider 7 (feed 76), and receiver 5 subscribes to the services from providers 6, 7, and 8 (feeds 65, 75, 85).

The network depicted herein is a secure private network 2 running under the Internet Protocol used by the public Internet and private “Intranets”, but with limited access to pre-authorised organisations (a so-called “extranet”). The network may be implemented as an Ethernet network, with an underlying optical network and minimum store-and-forward components. As shown for sites P1 and R1, each site provides a local area network 8, 9 connected to a respective router 80, 90 (for example Cisco 7300). The routers 80, 90 connect via a physical fibre path 81, 91 to a central switch (not shown) allowing interconnection between the various customers over the virtual network 2.

Typically, the routers 80, 90; fibre connections 81, 91; and central switch are all duplicated to provide resilience in the virtual network 2.

At the interfaces 82, 92 between the customer equipment 80, 90 and the network operator's equipment, provision is made for a firewall, both to protect the customers' data from each other and to protect the integrity of the network operator's equipment.

The extranet 2 offers its users high-bandwidth, low-latency network connections, superior to those available on the public internet. The present invention is concerned with allowing the users to monitor this performance, to determine that these properties are indeed being delivered. A user may subscribe to more than one extranet, and the invention allows such users to compare the performances of the different connections, and select the connection currently giving the optimum performance for the user's current needs.

As shown for customers P1 and R1, each customer site has an associated shadow router 83, 93. This router is part of the service provider's equipment, and is maintained through a separate interface 84, 94 that emulates the customer interface 82, 92. The shadow routers 83, 93 are configured to transmit probe messages 33 to each other, and to measure characteristics of the probes. Typically such characteristics will include successful/unsuccessful message delivery, availability, and round trip delay, the latter being measured either as a round-trip measure, or a one-way time by comparison with a standard clock. For round trip times, the shadow routers 83, 93 are designed to include the transit times of the corresponding customer routers 80, 90. Because the shadow routers are topologically close to the customer routers which they are emulating, the traffic density and other network characteristics are similar. These probes 33 allow latency and jitter to be measured on the virtual links between the routers. The jitter probes are configured to send small packets periodically, and data is collected regarding the round trip delays and the jitter of the packet streams.

The use of shadow routers on a separate interface 84, 94 allows the network operator to maintain control of them, and avoids any inconsistencies that might be caused by reconfiguration of the user equipment 80, 90. There are several advantages to using a shadow router. Firstly, they have no production traffic to affect, or to be affected by, any other features or loads imposed on them. They can be updated with new probes without touching the live router 80, 90, and it can be configured independently of the live routers, which may differ from one user location to another because of customer preference or the age of the installation.

The performance of the network depicted in FIG. 1 is monitored by a data acquisition and dissemination service carried over the network, as depicted in FIG. 2. For clarity, only two customers, 8, 9, are depicted. Each user 8 is provided with a respective data connection 78/98; to a Central Instrumentation Server (CIS) 4. Similar connections are provided for other users (9) but are omitted from the Figure for clarity. The central instrumentation server 4 is customer-facing, so firewalls are placed between the Point of Presence equipment and the CIS, with access controlled on an application/ip address basis. Authentication credentials are needed for customers to log in to view reports.

The Central Instrumentation Server 4 has a data collection (polling) function 43, a data feed processing function 44 and a data feed dissemination function 49. In co-operation with the polling function 43, each shadow server 83 collects performance data from the responses to the probes 33 etc, and transmits messages 38 to the Central Instrumentation Server 4, in response to polling requests generated by the central instrumentation server. The data processor 44 in the central instrumentation server 4 processes this data which is then converted by the data feed dissemination function 49 into an individual output 98 which is transmitted to the respective customer terminal 8. In this embodiment such information is provided as a presentation to the customer application in which data continuously updates, analogous to a “ticker” format in which data text scrolls continuously across a display screen. However, other formats for the continuous presentation of data may be used, such as graphical (analogue) displays. Each user 8, can also access online reports through a connection 78.

The Central Instrumentation Server (CIS) 4 is shown in more detail in FIG. 3. It can provide functionality dedicated to the network in the form of highly granular data, to provide reports to customers on network performance either continuously (for example as a customer “ticker” display), or in response to a predetermined condition such as a performance measure falling below a threshold value, or in response to a request from the user (e.g. through an online report).

The Central Instrumentation Server (CIS) 4 is controlled by a provisioning/configuration function 45 operating in co-operation with a service model 3, and shown in more detail in FIG. 4. The service model 3 comprises three main areas of information. Firstly, there is an infrastructure database 40, containing data relating to the equipment and connections making up the network 2; this information is discovered automatically through network monitoring systems 32 that monitor and retrieve network equipment configuration data. Secondly, a customer database 41 containing information such as customer identifiers, customer sites, and addresses; this information is generated by a service model administration function 21 from data entered through a supervisory function 30. Thirdly, there is authentication data 42, containing identification and password information that allow a user to log in to the data dissemination application 49 or online reporting application (47); this information is also generated by the service model administration function 21 from data entered through the supervisory function 30. Some of the values within this data, such as passwords etc, may be specified by the customers 83.

The supervisory function 30 is also used to identify and record associations 10 between the customer site/address information 41 and the network equipment and connections information 40, and associations 20 between the authentications/permissions 42 and the network equipment and connections information 40. This is also performed through the service model administration function 21.

The data 40, 41, 42 and data relationships 10, 20 that form the service model 3 are used by the configuration function 45 to provide measurement and reporting of the customer services. A central processor 27 uses data from the service model 3 to generate instructions to be performed by respective configuration servers 28, 29 for network elements such as the shadow routers 83, and for the Central Instrumentation Server 4.

The network configuration server 28 generates initial or updated configuration instructions to the shadow routers 83, 93 located at each customer site to cause them to measure network performance by generating probes 33 to monitor the performance of individual links between the shadow routers, and to periodically collect instrumented data and application metrics, and data relating to events and alerts.

The configuration processor 29 for the central server 4 configures aspects of the polling function 43, the data feed processing function 44, and the data feed dissemination function 49.

The polling function 43 transmits requests to the shadow routers 83, 93 to upload the data they have collected. Such requests may be made for each individual piece of information, or the request may specify the conditions upon which to upload data: for example in response to changes in the data values observed by the shadow router.

The polling function 43 creates data 46 in a format suitable for retrieval by users 8, 9 through online reports generated by a report server 47, also configured by the configuration processor 29. Such reports are delivered in response requests from users, subject to data 42 relating to user authentication and permissions. The polling function 43 additionally provides data to a data feed processing function 44. The data feed processing function 44 processes this data to generate a set of data 48 indicative of the current state of the network, and of individual components and links in the network, according to the data requirements specified in the service model 3. For this purpose, the data collected by the polling server 43 may be combined with other data collected by other means directly from the network 2, for example detecting routing failures, overall loadings etc, to provide input data for the data feed dissemination process 49.

User systems 8, 9 initiate a session with the data feed dissemination process 49 which transmits messages to the user at regular intervals. The user sessions are authenticated according to user credentials (e.g. userid and password) that are stored in the authentications/permissions area 42 of the service model 3. The information that is sent to any one user is determined through reference to information derived from the service model 3, including equipment and connections area 40, the linkages 20 to authentications/permissions area, and the linkages 10 to the customer site/address area 41.

1. A telecommunications network comprising a plurality of network terminations interconnected through the network, each network termination being connectable to network termination equipment configurable for the input or output of data communicated between the terminations over the network, two or more of the network terminations comprising monitoring means for monitoring the performance of traffic feeds between the network terminations, wherein each monitoring means comprises data generation and collection equipment independent of the network termination equipment, and the data collection and generation equipment is arranged to exchange test signals with other such equipment and to monitor the performance of said signals.

2. A telecommunications network according to claim 1, in which the equipment at each site can both transmit and receive such test signals.

3. A telecommunications network according to claim 1, in which a first equipment at one or more sites is configured to transmit signals carrying information relating to the time of transmission, and a second equipment at one or more sites is configured to receive such signals and to determine the time of receipt of such signals, and to determine therefrom the time elapsed between transmission and receipt.

4. A telecommunications network according to claim 1, wherein a first equipment at one or more sites is configured to generate a signal requesting a reply from a second such equipment, to detect a reply, and to determine the total time elapsed for the transmission and the reply.

5. A telecommunications network according to claim 4, wherein the signal generated by the first equipment is arranged to cause the second equipment to generate a measure of the time taken to perform a predetermined process, and to return an indication of the measure so generated, so that the round-trip transmission time to be determined by the first equipment may take account of the indicated time taken for the second equipment to perform the required process.

6. A telecommunications network according to claim 1, wherein one or more of the equipments is configured to measure jitter in transmission times.

7. A telecommunications network according to claim 1, wherein one or more of the equipments is configured to measure other properties of the data link.

8. A telecommunications network according to claim 1, further comprising a network monitoring server configured to instruct the monitoring equipment to generate the said test signals, and to transmit to the monitoring server data derived from the received signals.

9. A method of monitoring the performance of a telecommunications network, the network comprising a plurality of interconnected network terminations each connected to network termination equipment configurable for the input or output of data,
the method comprising the provision of monitoring means comprising data generation and collection equipment independent of the network termination equipment, and arranged to exchange test signals and to monitor the performance of said signals.

10. A method according to claim 9, in which the monitoring equipment at each site both transmits and receives such test signals.

11. A method according to claim 9, in which the monitoring equipment at a first site transmits signals to a second site carrying information relating to the time of transmission, and the monitoring equipment at the second site determines the time of receipt of such signals, and determines therefrom the time elapsed between transmission and receipt.

12. A method according to claim 11, in which the monitoring equipment at a first site transmits signals to a second site requesting a reply from the equipment at the second site, the said equipment at the second site transmits a reply, the equipment at the first site detects the reply and determines, from the time of receipt, the total time elapsed for the transmission and the reply.

13. A method according to claim 12, wherein the signal equipment at the second site generates a measure of the time taken to perform a predetermined process, and returns an indication of the measure so generated, and the round-trip transmission time determined by the equipment at the first site takes account of the indicated time taken for the second equipment to perform the process.

14. A method according to claim 9, wherein one or more of the monitoring equipments measures jitter in transmission times.

15. A method according to claim 9, wherein one or more of the monitoring equipments measures the quality of the data link between itself and other monitoring equipments.

16. A method according to claim 9, wherein a network monitoring server generates instructions to the monitoring equipment to generate the said test signals, and to transmit to the monitoring server data derived from the received signals.

17. A method according to claim 16, wherein each transmission from a monitoring equipment to the monitoring server is made in response to an individual download command from the monitoring server.

18. A method according to claim 17, wherein the monitoring server generates an initial command to each monitoring equipment specifying the conditions in which a transmission of data are to be sent by the monitoring equipment to the monitoring server.
